(19) United States
(12) Patent Application Publication
(10) Pub. No.: US 2026/0245338 A1
(43) Pub. Date: Aug. 20, 2026

(54) INFORMATION PROCESSING DEVICE AND INFORMATION PROCESSING METHOD

(71) Applicant: Kabushiki Kaisha Toshiba, Kawasaki-shi Kanagawa (JP)

(72) Inventors: Satoshi KONDO, Shinjuku Tokyo (JP); Hisaaki KATAGIRI, Kawasaki Kanagawa (JP); Yutaka OTA, Yokohama Kanagawa (JP); Tuan thanh TA, Kawasaki Kanagawa (JP)

(73) Assignee: Kabushiki Kaisha Toshiba, Kawasaki-shi Kanagawa (JP)

(21) Appl. No.: 19/462,132

(22) Filed: Jan. 28, 2026

(30) Foreign Application Priority Data
Feb. 17, 2025 (JP) 2025-023386

(51) Int. Cl. G06V 10/60; G01S 17/89

(52) U.S. Cl. CPC G06V 10/60; G01S 17/89

(57) ABSTRACT

An information processing device includes a distance detector configured to generate first point cloud data including distance information of an object included in original point cloud data; a difference extractor configured to extract third point cloud data from a difference between the first point cloud data and previously acquired second point cloud data; and a difference adjuster configured to generate an index to adjust an extraction amount of the difference, wherein the difference extractor extracts the third point cloud data from the difference based on the index.

### CROSS REFERENCE TO RELATED APPLICATIONS

This application is based upon and claims the benefit of priority from the prior Japanese Patent Application No. 2025-023386, filed on Feb. 17, 2025, the entire contents of which are incorporated herein by reference.

### FIELD

Embodiments described herein relate to an information processing device and an information processing method.

### BACKGROUND

A distance detection device can accurately detect the distance to an object due to evolution of light detection & ranging (LiDAR) technology, and thus is applied to a wide range of fields, such as an autonomous driving device and an object recognition device.

However, in LiDAR, the distance to an object is detected based on results of repeatedly receiving reflected light from the object, and accordingly, the amount of noise included in light received by LiDAR varies depending on the distance to the object, reflectance of the object, the presence of ambient light such as sunlight, and the like. The output level of a light receiving element of LiDAR varies depending on the presence of light reception, but when a threshold for determining the output level is set to a constant level, reflected light from the object cannot be accurately detected due to variation in the amount of noise, and the accuracy of distance detection of the object potentially decreases.

### BRIEF DESCRIPTION OF THE DRAWINGS

FIG. 1 is a block diagram illustrating a schematic configuration of an information processing device according to a first embodiment;

FIG. 2 is a block diagram illustrating a schematic configuration of the information processing device according to a second embodiment;

FIG. 3 is a diagram illustrating the correspondence relation between an object distance and a threshold in the second embodiment;

FIG. 4 is a diagram for description of processing by a difference extractor 3;

FIG. 5 is a diagram for description of processing operation of the difference extractor;

FIG. 6A is a diagram illustrating a difference image in a case where a peripheral pixel region of a background image is one-by-one pixels;

FIG. 6B is a diagram illustrating the difference image in a case where the peripheral pixel region is three-by-three pixels;

FIG. 6C is a diagram illustrating the difference image in a case where the peripheral pixel region is five-by-five pixels;

FIG. 7 is a block diagram illustrating a schematic configuration of the information processing device according to a third embodiment;

FIG. 8 is a diagram illustrating the correspondence relation between an object luminance and a threshold in the third embodiment;

FIG. 9 is a block diagram illustrating a schematic configuration of the information processing device according to a fourth embodiment;

FIG. 10 is a diagram illustrating the correspondence relation among the object distance, the object luminance, and a threshold in the fourth embodiment;

FIG. 11 is a block diagram illustrating a schematic configuration of the information processing device according to a fifth embodiment;

FIG. 12 is a diagram illustrating the correspondence relation between the object distance and a voxel size in the fifth embodiment;

FIG. 13 is a block diagram illustrating a schematic configuration of the information processing device according to a sixth embodiment;

FIG. 14 is a diagram illustrating the correspondence relation between the object luminance and the voxel size in the sixth embodiment;

FIG. 15 is a diagram illustrating the correspondence relation between the object luminance and the voxel size in a modification of the sixth embodiment;

FIG. 16 is a block diagram illustrating a schematic configuration of the information processing device according to a seventh embodiment;

FIG. 17 is a graph representing Expression (1);

FIG. 18 is a block diagram illustrating a schematic configuration of the information processing device inside which an adjustment signal α is generated; and

FIG. 19 is a flowchart illustrating processing operation of the information processing device in FIG. 18.

### DETAILED DESCRIPTION

According to one embodiment, an information processing device includes a distance detector configured to generate first point cloud data including distance information of an object included in original point cloud data; a difference extractor configured to extract third point cloud data from a difference between the first point cloud data and previously acquired second point cloud data; and a difference adjuster configured to generate an index to adjust an extraction amount of the difference, wherein the difference extractor extracts the third point cloud data from the difference based on the index.

Embodiments of an information processing device and an information processing method will be described below with reference to the accompanying drawings. The following description is made with focus on a main part of the information processing device, but the information processing device may include components or functions that are not illustrated or described. The following description does not exclude illustrated or described components or functions.

### First Embodiment

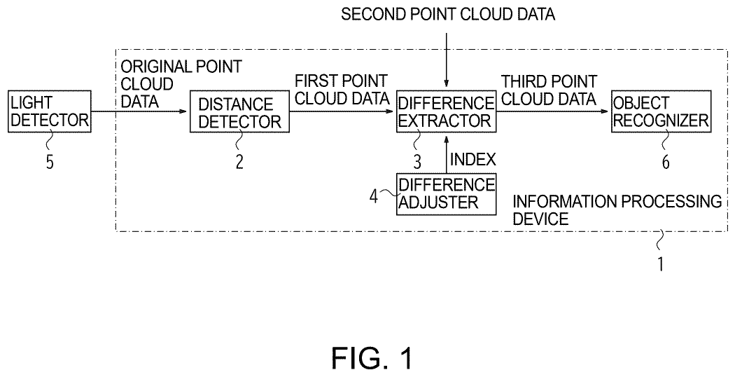

FIG. 1 is a block diagram illustrating a schematic configuration of an information processing device 1 according to a first embodiment. As illustrated in FIG. 1, the information processing device 1 according to the first embodiment includes a distance detector 2, a difference extractor 3, and a difference adjuster 4.

Original point cloud data (RAW data) output from a light detector 5 is input to the distance detector 2. The light detector 5 emits light to an object and receives light reflected by the object. For example, the light detector 5 scans the emission direction of light in a one-dimensional or two-dimensional direction and receives reflected light from an object present in a three-dimensional space. The light detector 5 may also have a function of variably controlling the scanning range of light. The light detector 5 is, for example, a LiDAR device provided separately from the information processing device 1. Alternatively, the light detector 5 may be incorporated in the information processing device 1.

The distance detector 2 generates first point cloud data including object distance information included in the original point cloud data. The density of the first point cloud data becomes coarse as the distance increases, and the density of the first point cloud data becomes dense as the distance decreases. In this manner, the object distance information can be detected by the coarseness and denseness of the first point cloud data. The first point cloud data is data in which the distance information is added to data of each point. More precisely, each point has orientation information (φ and θ components in polar coordinates) corresponding to the irradiation direction of a laser beam from the LiDAR device, and distance information d to an object present in the orientation of the point. A distance image is an image in which the distance information d of each point is arranged as a two-dimensional image. The first point cloud data may include the distance image and may include data obtained by converting the polar coordinates φ and θ and the distance information d of each point into XYZ coordinates.

The difference extractor 3 extracts third point cloud data from the difference between the first point cloud data generated by the distance detector 2 and second point cloud data acquired in the past (i.e., previously acquired second point cloud data). The second point cloud data acquired in the past may be point cloud data acquired in the past, or may be point cloud data obtained by performing averaging processing on the point cloud data acquired in the past. In the present specification, the difference between the first point cloud data and the second point cloud data is also referred to as difference point cloud data. The first point cloud data is generated based on the original point cloud data output from the light detector 5.

The second point cloud data is a three-dimensional background image of one frame and is data in which a point cloud does not change with time. The information processing device 1 according to the first embodiment may include a non-illustrated storage configured to store the second point cloud data.

The first point cloud data is a three-dimensional distance image including the background image represented by the second point cloud data. More specifically, the first point cloud data is a distance image obtained by adding the object distance information to the background image. The difference point cloud data between the first point cloud data and the second point cloud data indicates a distance difference for each pixel between the distance image and the background image.

The third point cloud data extracted from the difference point cloud data is point cloud data obtained by extracting at least part of the difference (difference point cloud data) between the first point cloud data and the second point cloud data. In other words, the third point cloud data is a difference image between the distance image and the background image. As described later, for example, the difference extractor 3 extracts the third point cloud data from the difference point cloud data by removing noise included in the difference point cloud data.

The difference adjuster 4 generates an index for adjusting the extraction amount of the difference (difference point cloud data). For example, the difference adjuster 4 generates the above-described index based on the first point cloud data or two-dimensional image data. Alternatively, the difference adjuster 4 may generate the above-described index based on an object recognition result.

The index is, for example, a threshold for comparing with the difference (difference point cloud data). Alternatively, the index is the size of a voxel (hereinafter referred to as a voxel size). A voxel refers to a three-dimensional unit region in which the first point cloud data and the second point cloud data in a three-dimensional space are divided into sizes in accordance with the object distance. Each voxel includes the divided first point cloud data or second point cloud data. Each voxel has a size in accordance with the object distance corresponding to point cloud data included inside the voxel.

In a case where the index is the voxel size, the difference extractor 3 calculates a difference between a plurality of voxels in which the first point cloud data is divided and a plurality of voxels in which the second point cloud data is divided. For example, in a case where the first point cloud data includes point cloud data of an object that is not present in the background image, the first point cloud data includes a new voxel that is not present in the plurality of voxels in which the second point cloud data is divided. By calculating the difference, a voxel that is not present in the plurality of voxels in which the second point cloud data is divided is taken out. In a case where the index is the voxel size, the difference extractor 3 extracts, as the third point cloud data, point cloud data in a voxel obtained by calculating the difference.

As illustrated in FIG. 1, the information processing device 1 according to the first embodiment may include an object recognizer 6. The object recognizer 6 recognizes an object based on the third point cloud data extracted by the difference extractor 3. As described above, the third point cloud data is point cloud data extracted from the difference (difference point cloud data) between the first point cloud data constituting the distance image and the second point cloud data constituting the background image, and object information is included in the third point cloud data. Since the difference extractor 3 extracts the third point cloud data exceeding a threshold from the difference point cloud data, the third point cloud data is data in which a noise component is reduced. Thus, the object recognizer 6 can accurately recognize an object from the third point cloud data.

The information processing device 1 according to the first embodiment may only detect presence of an object based on the third point cloud data without performing object recognition.

In this manner, in the first embodiment, an index for adjusting the extraction amount of the difference (difference point cloud data) is generated, and the third point cloud data is extracted from the difference (difference point cloud data) by using the generated index. Accordingly, for example, the index can be adjusted in accordance with the amount of noise included in the first point cloud data, and as a result, the third point cloud data becomes less susceptible to influence of noise. Thus, an object can be accurately recognized from the third point cloud data.

### Second Embodiment

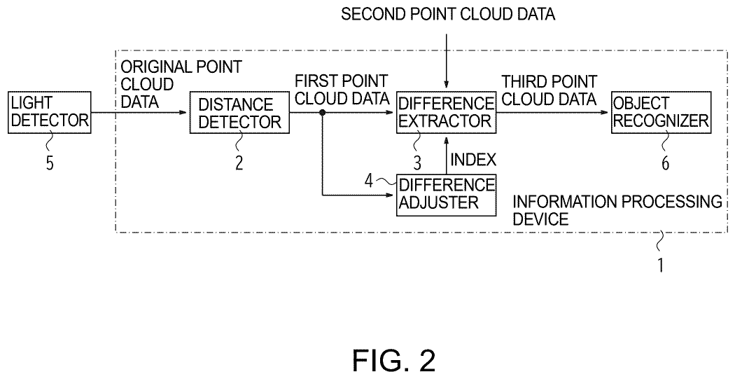

FIG. 2 is a block diagram illustrating a schematic configuration of the information processing device 1 according to a second embodiment. The information processing device 1 according to the second embodiment illustrated in FIG. 2 has the same block configuration as in FIG. 1, but the first point cloud data generated by the distance detector 2 is input to the difference adjuster 4. The first point cloud data generated by the distance detector 2 is not necessarily input to the difference adjuster 4 in FIG. 1, and thus an arrow line illustrating an input path of the difference adjuster 4 is omitted in FIG. 1.

Based on the distance information detected by the distance detector 2, the difference adjuster 4 in FIG. 2 generates, as the index, a threshold for extracting the third point cloud data from the difference point cloud data between the first point cloud data and the second point cloud data. The difference extractor 3 extracts the third point cloud data based on the difference point cloud data exceeding the threshold. The difference point cloud data is data representing the distance difference for each pixel between the distance image and the background image, and the third point cloud data constituting the difference image is point cloud data of pixels having a distance difference equal to or greater than the threshold.

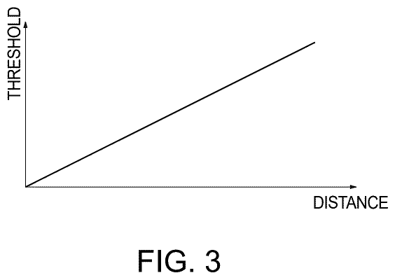

FIG. 3 is a diagram illustrating the correspondence relation between the object distance and the threshold in the second embodiment. In FIG. 3, the horizontal axis represents the object distance, and the vertical axis represents the threshold. As illustrated in FIG. 3, the threshold increases as the distance increases, and the threshold decreases as the distance decreases. As the object distance increases, the density of the first point cloud data becomes coarser and the amount of noise increases, and thus the threshold is increased. FIG. 3 illustrates an example in which the distance and the threshold have a linear relation, but the relation may be non-linear.

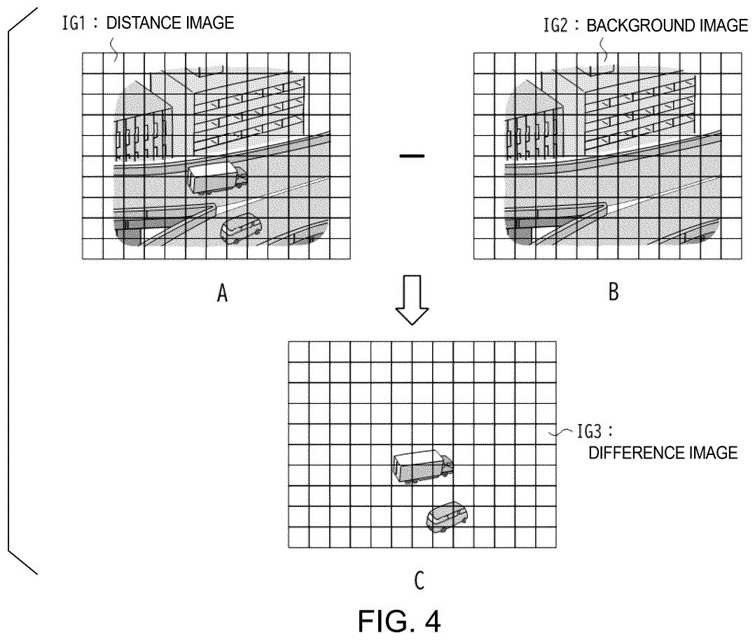

FIG. 4 is a diagram for description of processing by the difference extractor 3. The left part A of FIG. 4 is a diagram illustrating an example of a distance image IG1 represented by the first point cloud data generated by the distance detector. The right part B of FIG. 4 is a diagram illustrating an example of a background image IG2 represented by the second point cloud data. The bottom part C of FIG. 4 is a diagram illustrating a difference image IG3 between the distance image IG1 in the left part A of FIG. 4 and the background image IG2 in the right part B of FIG. 4. The distance image IG1, the background image IG2, and the difference image IG3 are all point cloud data, but notations of point clouds are omitted in FIGS. 4A, 4B, and 4C for simplification.

The difference extractor 3 extracts the third point cloud data (the bottom part of FIG. 4) constituting the difference image IG3 and exceeding the threshold from the difference point cloud data between the distance image IG1 represented by the first point cloud data in the left part A of FIG. 4 and the background image IG2 represented by the second point cloud data in the right part B of FIG. 4.

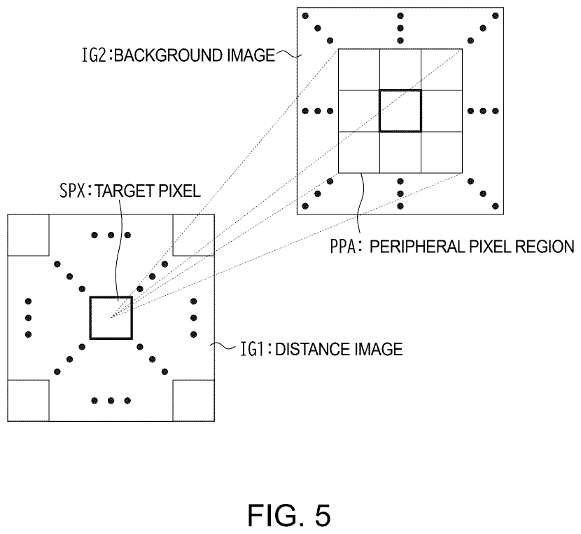

FIG. 5 is a diagram for description of processing operation of the difference extractor 3. The difference extractor 3 sequentially selects, as a target pixel SPX, each of a plurality of pixels constituting the distance image IG1 represented by the first point cloud data, and deletes the target pixel SPX from candidates of the difference image if at least one pixel the distance difference of which from the target pixel SPX exceeds the threshold is present in a peripheral pixel region PPA centered at a pixel of the background image IG2 represented by the second point cloud data and corresponding to the selected target pixel SPX. Accordingly, a noise component included in the distance image IG1 can be efficiently deleted, and the amount of the third point cloud data constituting the difference image can be reduced.

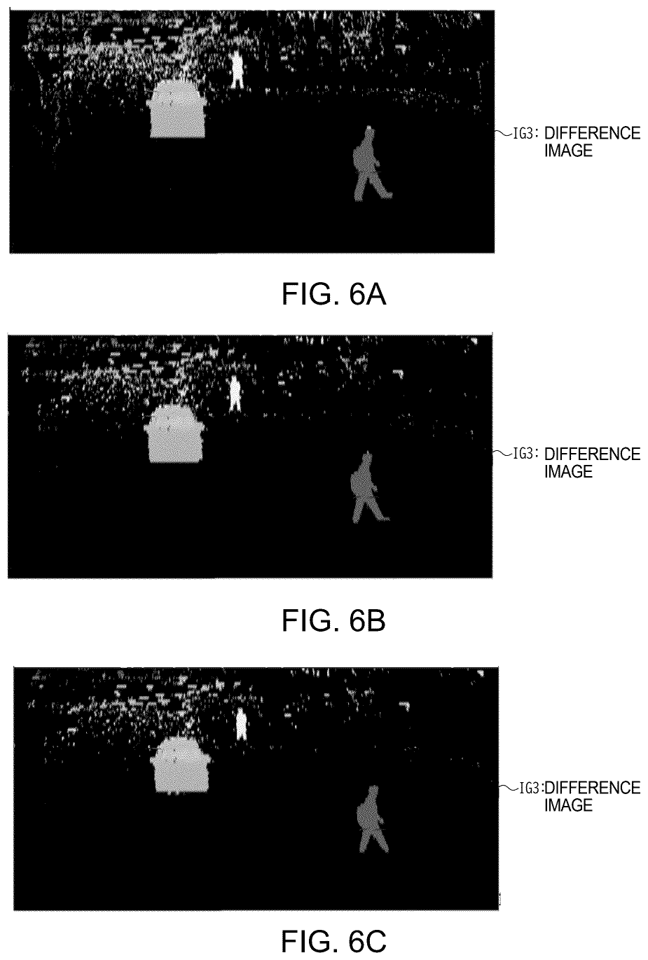

FIG. 6A is a diagram illustrating the difference image in a case where the peripheral pixel region of the background image is one-by-one pixels, FIG. 6B is a diagram illustrating the difference image in a case where the peripheral pixel region is three-by-three pixels, and FIG. 6C is a diagram illustrating the difference image in a case where the peripheral pixel region is five-by-five pixels.

As understood from FIGS. 6A to 6C, a larger amount of the third point cloud data included in the difference image can be reduced as the area of the peripheral pixel region of the background image, which is compared with the target pixel of the distance image, is larger.

Note that the processing operation of the difference extractor 3 does not necessarily need to be performed by the method of FIG. 5. For example, whether to include the target pixel in the difference image may be determined depending on whether a distance difference based on the difference between an average value of pixels in the peripheral pixel region and the target pixel exceeds a threshold.

In this manner, in the second embodiment, a threshold for extracting the third point cloud data from the difference point cloud data is adjusted in accordance with the object distance, and thus the third point cloud data becomes less susceptible to influence of noise by, for example, increasing the threshold in a case where the object distance is long as compared to a case where the object distance is small. Accordingly, according to the second embodiment, variation of the extraction accuracy of the third point cloud data can be reduced even when the object distance changes.

### Third Embodiment

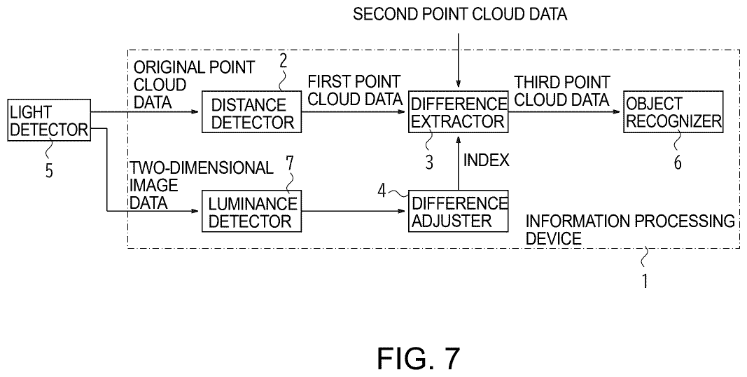

FIG. 7 is a block diagram illustrating a schematic configuration of the information processing device 1 according to a third embodiment. As illustrated in FIG. 7, the information processing device 1 according to the third embodiment includes a luminance detector 7 in addition to the configuration in FIG. 2.

The light detector 5 outputs the original point cloud data (RAW data) as well as two-dimensional image data. The two-dimensional image data is data having luminance information for each pixel.

The luminance detector 7 detects luminance information of each pixel based on the two-dimensional image data. The luminance detector 7 may determine the luminance value of a target pixel by, for example, averaging the luminance values of a plurality of pixels around the target pixel.

Based on the luminance information detected for each pixel by the luminance detector 7, the difference adjuster 4 generates, as the index, a threshold for extracting the third point cloud data from the difference point cloud data. For example, for a pixel having a high luminance value, the difference adjuster 4 lowers the threshold for a corresponding portion of the difference point cloud data.

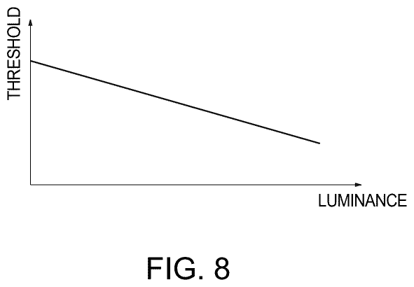

FIG. 8 is a diagram illustrating the correspondence relation between the object luminance and the threshold in the third embodiment. In FIG. 8, the horizontal axis represents the object luminance, and the vertical axis represents the threshold. As illustrated in FIG. 7, the threshold decreases as the luminance increases, and the threshold increases as the luminance decreases. In a case where the luminance is high, distinction from noise included in the difference point cloud data is easy, and thus the threshold is lowered. On the other hand, in a case where the luminance is low, distinction from noise included in the difference point cloud data is difficult, and thus the threshold is increased.

In this manner, in the third embodiment, a threshold for extracting the third point cloud data from the difference point is adjusted in accordance with the luminance, and thus the extraction accuracy of the third point cloud data can be improved.

### Fourth Embodiment

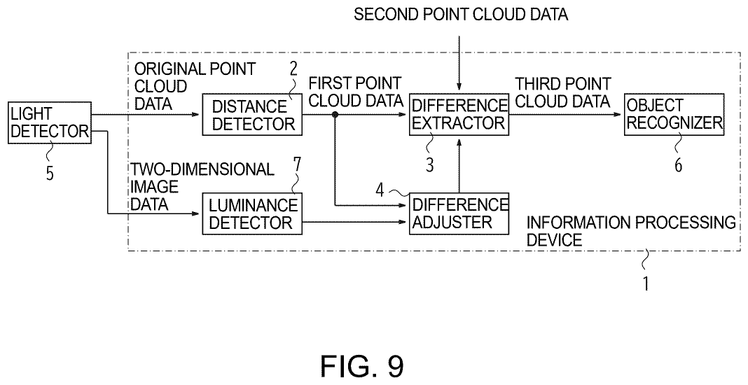

FIG. 9 is a block diagram illustrating a schematic configuration of the information processing device 1 according to a fourth embodiment. As illustrated in FIG. 9, the information processing device 1 according to the fourth embodiment has the same block configuration as in FIG. 7, but the difference adjuster 4 in FIG. 9 performs processing operation different from that of the difference adjuster 4 in FIG. 7, and the difference extractor 3 in FIG. 9 performs processing operation different from that of the difference extractor 3 in FIG. 7.

Based on the distance information and the luminance information, the difference adjuster 4 in FIG. 9 generates, as the index, a threshold for extracting the third point cloud data from the difference point cloud data. More specifically, the difference adjuster 4 variably controls the correspondence relation between the object distance and the threshold in accordance with the object luminance.

The difference extractor 3 in FIG. 9 extracts the third point cloud data based on the difference point cloud data exceeding the threshold. More specifically, the difference extractor 3 variably controls the threshold in accordance with the object distance and the object luminance.

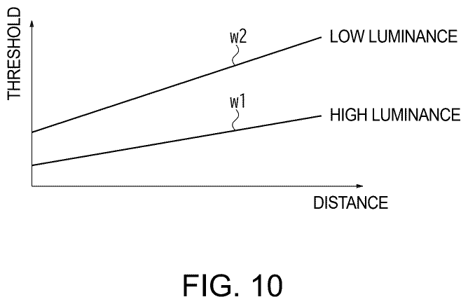

FIG. 10 is a diagram illustrating the correspondence relation among the object distance and the object luminance and the threshold in the fourth embodiment. In FIG. 10, the horizontal axis represents the object distance, and the vertical axis represents the threshold. FIG. 10 illustrates a correspondence relation w1 in a case of high luminance and a correspondence relation w2 in a case of low luminance. The correspondence relations w1 and w2 have mutually different gradients. In other words, the degree of change of the threshold when the object distance changes is different between high luminance and low luminance. The degree of change of the threshold is smaller as the object luminance is higher. The correspondence relations w1 and w2 in FIG. 10 are merely exemplary.

In this manner, in the fourth embodiment, the threshold is variably controlled in accordance with the object distance and the object luminance, and thus an optimum threshold can be set in accordance with the object distance and the object luminance, and the accuracy of extraction of the third point cloud data from the difference point cloud data can be further improved.

### Fifth Embodiment

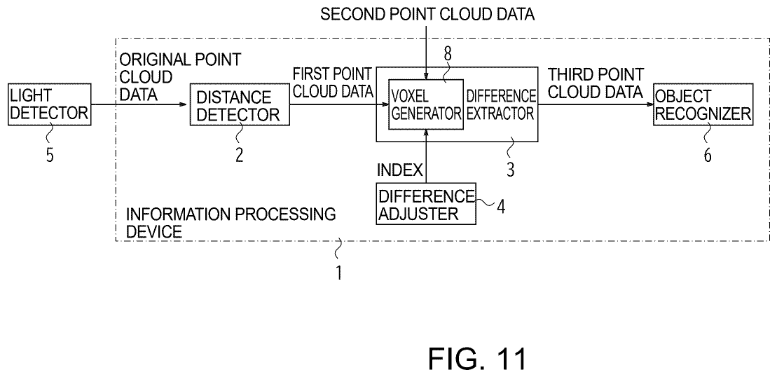

FIG. 11 is a block diagram illustrating a schematic configuration of the information processing device 1 according to a fifth embodiment. As illustrated in FIG. 11, the information processing device 1 according to the fifth embodiment includes the distance detector 2, the difference extractor 3 including a voxel generator 8, and the difference adjuster 4.

The distance detector 2 generates the first point cloud data including the object distance information included in the original point cloud data (RAW data).

The voxel generator 8 divides the first point cloud data into a plurality of voxels based on the index, and also divides the second point cloud data into a plurality of voxels based on the index. The first point cloud data includes the object distance information. Specifically, the first point cloud data is point cloud data of density corresponding to the object distance, and is data obtained by adding the distance information to data of each point. In a case where the first point cloud data includes a plurality of pieces of point cloud data corresponding to a plurality of objects, and each point cloud data is stored in a voxel having a size in accordance with the distance.

The plurality of voxels in which the first point cloud data is divided do not have the same size but each have a size in accordance with the object distance information corresponding to the point cloud data inside the voxel. For example, the voxel size increases in a case where the point cloud data included in a voxel relates to a distant object. On the other hand, the voxel size decreases in a case where the point cloud data included in a voxel relates to a near object.

The difference adjuster 4 generates a voxel size correlated with distance as the index. The difference adjuster 4 can adjust, by the index, the degree of change of the voxel size in accordance with distance change.

The voxel generator 8 generates a plurality of voxels in which the first point cloud data is divided based on the index, and a plurality of voxels in which the second point cloud data is divided based on the index. The difference extractor 3 extracts, as the third point cloud data, point cloud data included in voxels of the difference between the plurality of voxels in which the first point cloud data is divided based on the index and the plurality of voxels in which the second point cloud data is divided based on the index.

The difference between the plurality of voxels in which the first point cloud data is divided based on the index and the plurality of voxels in which the second point cloud data is divided based on the index includes voxels different from the plurality of voxels in which the second point cloud data is divided. Each voxel of the difference includes point cloud data representing an object. Each voxel of the difference has a size corresponding to the distance of an object in the voxel.

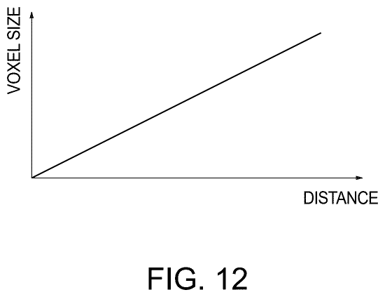

FIG. 12 is a diagram illustrating the index generated by the difference adjuster 4 in the fifth embodiment. In FIG. 12, the horizontal axis represents the object distance, and the vertical axis represents the voxel size. As illustrated in FIG. 12, the index includes information indicating the degree of change of the voxel size in accordance with change of the object distance.

The voxel size of each voxel extracted by the difference extractor 3 is variably controlled by adjusting the index by the difference adjuster 4.

In this manner, in the fifth embodiment, the difference between a plurality of voxels in which the first point cloud data is divided based on the index and a plurality of voxels in which the second point cloud data is divided based on the index is calculated, and the third point cloud data in voxels of the difference is extracted. In the fifth embodiment, the degree of change of the voxel size in accordance with change of the object distance is adjusted by the index, and the third point cloud data is extracted by using the voxel size thus adjusted, and thus the extraction accuracy of the third point cloud data can be improved.

### Sixth Embodiment

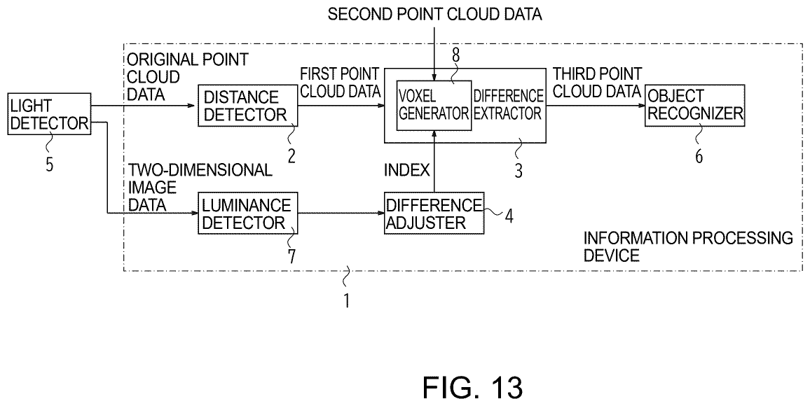

FIG. 13 is a block diagram illustrating a schematic configuration of the information processing device 1 according to a sixth embodiment. As illustrated in FIG. 13, the information processing device 1 according to the sixth embodiment includes the luminance detector 7 in addition to the configuration in FIG. 11. The luminance detector 7 detects luminance information of each pixel based on the two-dimensional image data that is input together with the original point cloud data.

Based on the luminance information, the difference adjuster 4 generates a voxel size correlated with distance as the index. The difference extractor 3 includes the voxel generator 8. The voxel generator 8 generates a plurality of voxels in which the first point cloud data is divided based on the index, and a plurality of voxels in which the second point cloud data is divided based on the index. The difference extractor 3 extracts the third point cloud data in voxels of the difference between the plurality of voxels in which the first point cloud data is divided based on the index and the plurality of voxels in which the second point cloud data is divided based on the index.

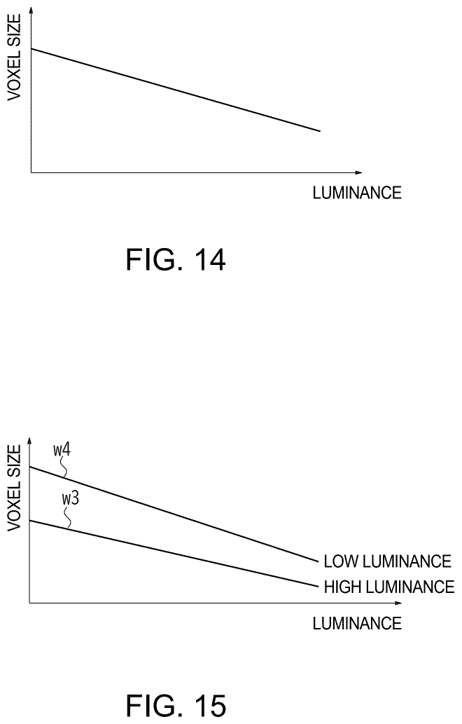

FIG. 14 is a diagram illustrating the index generated by the difference adjuster 4 in the sixth embodiment. In FIG. 14, the horizontal axis represents the object luminance, and the vertical axis represents the voxel size. The index includes information indicating the degree of change of the voxel size in accordance with change of the object luminance. As illustrated in FIG. 14, the voxel size as the index decreases as the object luminance increases.

The difference extractor 3 extracts, as the third point cloud data, point cloud data included in voxels of the difference between the plurality of voxels in which the first point cloud data is divided based on the index and the plurality of voxels in which the second point cloud data is divided based on the index. Accordingly, the third point cloud data with less noise can be extracted.

As a modification of the information processing device 1 according to the sixth embodiment, the difference adjuster 4 may generate the voxel size as the index based on the distance information and the luminance information.

FIG. 15 is a diagram illustrating the index generated by the difference adjuster 4 in the modification of the sixth embodiment. In FIG. 15, the horizontal axis represents the object luminance, and the vertical axis represents the voxel size. FIG. 15 illustrates an index w3 in a case of high luminance and an index w4 in a case of low luminance. The indexes w3 and w4 have mutually different gradients. The degree of change of the voxel size is smaller as the object luminance is higher. The indexes w3 and w4 in FIG. 15 are merely exemplary.

In this manner, in the sixth embodiment, the voxel size as the index is adjusted in accordance with the object luminance, and the third point cloud data in voxels of the difference between a plurality of voxels in which the first point cloud data is divided based on the index and a plurality of voxels in which the second point cloud data is divided based on the index is extracted. Accordingly, the third point cloud data with less noise can be extracted irrespective of the luminance.

### Seventh Embodiment

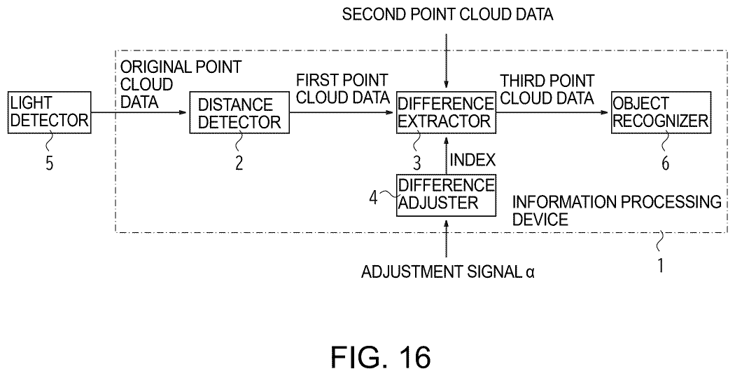

FIG. 16 is a block diagram illustrating a schematic configuration of the information processing device 1 according to a seventh embodiment. The information processing device 1 according to the seventh embodiment illustrated in FIG. 16 has the same block configuration as in FIG. 1, but the difference adjuster 4 in FIG. 16 performs processing operation different from that of the difference adjuster 4 in FIG. 1.

Although the difference adjuster 4 in FIG. 1 adjusts the index based on, for example, the first point cloud data or the two-dimensional image data, the difference adjuster 4 in FIG. 16 adjusts the index based on an adjustment signal α and a function f(distance or luminance). The function f(distance or luminance) is a function that calculates the index by using at least one of distance or luminance as an input parameter. The shape of the function f is freely selected. The index is, for example, a threshold or a voxel size. The difference adjuster 4 adjusts the index based on, for example, Expression (1) below. The adjustment signal α is a real number other than zero.

$$Index = f ( distance or luminance ) \times α \qquad ( 1 )$$

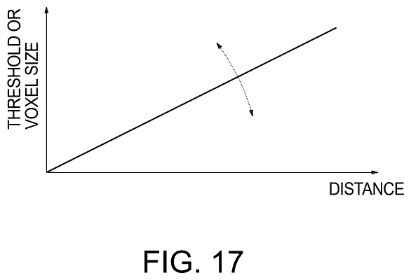

FIG. 17 is a graph representing Expression (1). In FIG. 17, the horizontal axis represents the object distance, and the vertical axis represents the threshold or the voxel size. The shape of the function f, for example, the gradient of the function f can be adjusted by the adjustment signal α.

The adjustment signal α may be input from outside the information processing device 1, or may be a signal generated inside the information processing device 1.

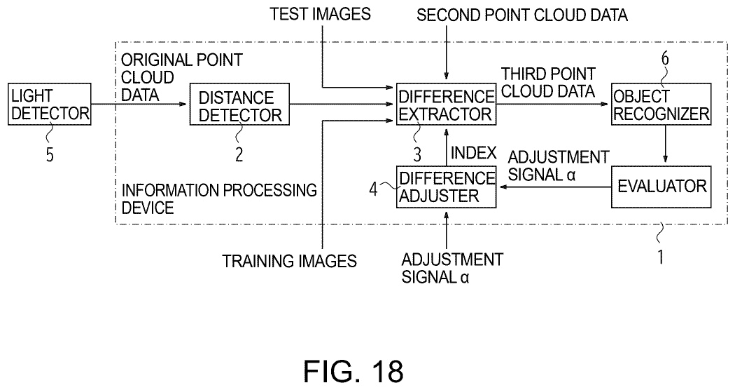

FIG. 18 is a block diagram illustrating a schematic configuration of the information processing device 1 inside which the adjustment signal α is generated. The information processing device 1 in FIG. 18 includes a processing block related to generation of the adjustment signal α. Specifically, the information processing device 1 in FIG. 18 includes an evaluator 9 and a test image storage 10 in addition to the configuration of the information processing device 1 in FIG. 1.

The object recognizer 6 recognizes an object based on the third point cloud data extracted by the difference extractor 3. For example, the object recognizer 6 includes an object recognition model, and outputs the result of object recognition from the object recognition model by inputting the third point cloud data extracted by the difference extractor 3 into the object recognition model.

Training images for training the object recognition model, and test images for evaluating the trained object recognition model are input to the difference extractor 3.

The evaluator 9 evaluates the object recognition accuracy of the object recognizer 6 based on the object recognition result output from the object recognizer 6 when the test images are input to the object recognizer 6.

The difference adjuster 4 adjusts the adjustment signal α based on the evaluation result of the evaluator 9, and updates the index based on the adjusted adjustment signal α. The difference extractor 3 repeats processing of the evaluator 9 and the difference adjuster 4 a predetermined number of times, and then extracts the third point cloud data from the difference point cloud data based on the index of the highest accuracy evaluated by the evaluator 9.

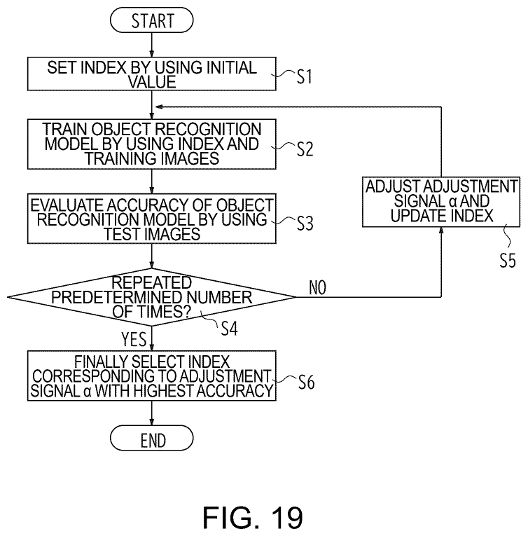

FIG. 19 is a flowchart illustrating processing operation of the information processing device 1 in FIG. 18. First, the difference extractor 3 sets the index by using an initial value α0 of the adjustment signal (step S1). The index is, for example, a threshold or a box size.

Subsequently, the object recognizer 6 trains an object recognition model by using the index set at step S1 and training images (step S2). The object recognition model is a model that outputs a recognition result of an object included in an input image by using the input image and the index as input parameters. Since object information included in the training images is known in advance, the object recognition model is trained at step S2 by comparing the object recognition result output from the object recognition model with the known object information.

Subsequently, the evaluator 9 evaluates the accuracy of the object recognition model by inputting test images not used in the training and the index to the object recognition model (step S3).

Subsequently, it is determined whether the processing at steps S2 to S5 is repeated a predetermined number of times (step S4). In a case where the determination at step S4 is “NO”, the adjustment signal α is adjusted and the index is updated (step S5). Thereafter, the processing at step S2 and later is performed by using the updated index.

In a case where the determination at step S4 is “YES”, the index corresponding to the adjustment signal α with highest accuracy is finally selected (step S6).

In this manner, in the seventh embodiment, the index can be freely adjusted by the adjustment signal α, and thus the index with which the object recognition accuracy of the object recognizer 6 is optimal can be easily searched.

At least a part or all of the functions of each unit (e.g., the distance detector 2, the difference extractor 3, the difference adjuster 4, the object recognizer 6, and the luminance detector 7) of the information processing device 1 in each of the above-described embodiments may be configured using circuitry. For example, each of these units may be realized by a dedicated hardware circuit (e.g., an Application Specific Integrated Circuit (ASIC) or a Field Programmable Gate Array (FPGA)) designed to perform a specific function. Alternatively, each of these units may be realized by processing circuitry in which a processor such as a Central Processing Unit (CPU) or a Graphics Processing Unit (GPU) executes a program (software) stored in a memory.

The embodiments as described before may be configured as below.

### CLAUSES

### Clause 1

An information processing device comprising:
a distance detector configured to generate first point cloud data including distance information of an object included in original point cloud data;
a difference extractor configured to extract third point cloud data from a difference between the first point cloud data and previously acquired second point cloud data; and
a difference adjuster configured to generate an index to adjust an extraction amount of the difference,
wherein the difference extractor extracts the third point cloud data from the difference based on the index.

### Clause 2

The information processing device according to claim 1, wherein the second point cloud data constitutes a three-dimensional background image of one frame, and
the first point cloud data constitutes a three-dimensional distance image including the background image.

### Clause 3

The information processing device according to claim 1 or 2, wherein the difference adjuster generates, as the index, a threshold to adjust the extraction amount of the difference based on the distance information included in the first point cloud data, and
the difference extractor extracts the third point cloud data based on the difference exceeding the threshold.

### Clause 4

The information processing device according to claim 3, wherein the difference adjuster variably controls the threshold in accordance with a distance to the object.

### Clause 5

The information processing device according to claim 4, wherein the difference adjuster increases the threshold as the distance to the object increases.

### Clause 6

The information processing device according to claim 1 or 2, further comprising: a luminance detector configured to detect luminance information for each pixel based on two-dimensional image data input together with the original point cloud data,
wherein the difference adjuster generates, as the index, a threshold to adjust the extraction amount of the difference based on the luminance information, and
the difference extractor extracts the third point cloud data based on the difference exceeding the threshold.

### Clause 7

The information processing device according to claim 6, wherein the difference adjuster variably controls the threshold in accordance with luminance of each pixel.

### Clause 8

The information processing device according to claim 6 or 7, wherein the difference adjuster decreases the threshold as the luminance increases.

### Clause 9

The information processing device according to claim 1 or 2, further comprising: a luminance detector configured to detect luminance information for each pixel based on two-dimensional image data input together with the original point cloud data,
wherein the difference adjuster generates, as the index, a threshold to adjust the extraction amount of the difference based on the distance information and the luminance information, and
the difference extractor extracts the third point cloud data based on the difference exceeding the threshold.

### Clause 10

The information processing device according to claim 9, wherein the difference extractor variably controls the threshold in accordance with a distance to the object and luminance.

### Clause 11

The information processing device according to claim 10, wherein the difference adjuster variably controls a correspondence relation between the distance to the object and the threshold in accordance with luminance of the object.

### Clause 12

The information processing device according to claim 1 or 2, wherein the difference extractor extracts the third point cloud data in a voxel of a difference between
(i) a plurality of voxels in which the first point cloud data is divided based on the index and
(ii) a plurality of voxels in which the second point cloud data is divided based on the index, and
   the difference adjuster generates a size of the voxel to adjust the extraction amount of the difference as the index.

### Clause 13

The information processing device according to claim 12, wherein the difference adjuster variably controls the size of the voxel in accordance with a distance to the object.

### Clause 14

The information processing device according to claim 13, wherein the difference adjuster increases the size of the voxel as the distance to the object increases.

### Clause 15

The information processing device according to claim 1 or 2, further comprising: a luminance detector configured to detect luminance information of each of a plurality of voxels in which the first point cloud data and the second point cloud data are divided based on the index, based on two-dimensional image data input together with the original point cloud data,
wherein the difference extractor extracts, based on the luminance information, the third point cloud data in a voxel of a difference between
   (i) the plurality of voxels in which the first point cloud data is divided based on the index and
   (ii) the plurality of voxels in which the second point cloud data is divided based on the index.

### Clause 16

The information processing device according to claim 15, wherein the difference adjuster variably controls the index representing a degree of change of a size of the voxel with respect to a change in a distance to the object, based on the luminance information for each voxel.

### Clause 17

The information processing device according to any one of claims 1 to 16, further comprising an object recognizer configured to recognize an object based on the third point cloud data.

### Clause 18

The information processing device according to any one of claims 1 to 17, wherein the difference adjuster adjusts the index based on an adjustment signal, and
the difference extractor extracts the third point cloud data from the difference based on the index adjusted by the difference adjuster.

### Clause 19

The information processing device according to claim 18, further comprising: an evaluator configured to evaluate accuracy of the third point cloud data extracted by the difference extractor using the first point cloud data of a test image,
wherein the difference adjuster adjusts the index based on the adjustment signal based on an evaluation result of the evaluator, and
the difference extractor repeats processing of the evaluator and the difference adjuster alternately a predetermined number of times, and then extracts the third point cloud data from the difference based on the index with highest accuracy evaluated by the evaluator.

### Clause 20

An information processing method comprising:
extracting third point cloud data based on a difference between newly acquired first point cloud data and previously acquired second point cloud data; and
generating an index to adjust an extraction amount of the difference based on the first point cloud data; and
extracting the third point cloud data from the difference based on the index.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing device comprising:
a distance detector configured to generate first point cloud data including distance information of an object included in original point cloud data;
a difference extractor configured to extract third point cloud data from a difference between the first point cloud data and previously acquired second point cloud data; and
a difference adjuster configured to generate an index to adjust an extraction amount of the difference,
wherein the difference extractor extracts the third point cloud data from the difference based on the index.

2. The information processing device according to claim 1, wherein the second point cloud data constitutes a three-dimensional background image of one frame, and
the first point cloud data constitutes a three-dimensional distance image including the background image.

3. The information processing device according to claim 1, wherein the difference adjuster generates, as the index, a threshold to adjust the extraction amount of the difference based on the distance information included in the first point cloud data, and
the difference extractor extracts the third point cloud data based on the difference exceeding the threshold.

4. The information processing device according to claim 3, wherein the difference adjuster variably controls the threshold in accordance with a distance to the object.

5. The information processing device according to claim 4, wherein the difference adjuster increases the threshold as the distance to the object increases.

6. The information processing device according to claim 1, further comprising: a luminance detector configured to detect luminance information for each pixel based on two-dimensional image data input together with the original point cloud data,
wherein the difference adjuster generates, as the index, a threshold to adjust the extraction amount of the difference based on the luminance information, and
the difference extractor extracts the third point cloud data based on the difference exceeding the threshold.

7. The information processing device according to claim 6, wherein the difference adjuster variably controls the threshold in accordance with luminance of each pixel.

8. The information processing device according to claim 6, wherein the difference adjuster decreases the threshold as the luminance increases.

9. The information processing device according to claim 1, further comprising: a luminance detector configured to detect luminance information for each pixel based on two-dimensional image data input together with the original point cloud data,
wherein the difference adjuster generates, as the index, a threshold to adjust the extraction amount of the difference based on the distance information and the luminance information, and
the difference extractor extracts the third point cloud data based on the difference exceeding the threshold.

10. The information processing device according to claim 9, wherein the difference extractor variably controls the threshold in accordance with a distance to the object and luminance.

11. The information processing device according to claim 10, wherein the difference adjuster variably controls a correspondence relation between the distance to the object and the threshold in accordance with luminance of the object.

12. The information processing device according to claim 1, wherein the difference extractor extracts the third point cloud data in a voxel of a difference between
(i) a plurality of voxels in which the first point cloud data is divided based on the index and
(ii) a plurality of voxels in which the second point cloud data is divided based on the index, and
the difference adjuster generates a size of the voxel to adjust the extraction amount of the difference as the index.

13. The information processing device according to claim 12, wherein the difference adjuster variably controls the size of the voxel in accordance with a distance to the object.

14. The information processing device according to claim 13, wherein the difference adjuster increases the size of the voxel as the distance to the object increases.

15. The information processing device according to claim 1, further comprising: a luminance detector configured to detect luminance information of each of a plurality of voxels in which the first point cloud data and the second point cloud data are divided based on the index, based on two-dimensional image data input together with the original point cloud data,
wherein the difference extractor extracts, based on the luminance information, the third point cloud data in a voxel of a difference between
(i) the plurality of voxels in which the first point cloud data is divided based on the index and
(ii) the plurality of voxels in which the second point cloud data is divided based on the index.

16. The information processing device according to claim 15, wherein the difference adjuster variably controls the index representing a degree of change of a size of the voxel with respect to a change in a distance to the object, based on the luminance information for each voxel.

17. The information processing device according to claim 1, further comprising an object recognizer configured to recognize an object based on the third point cloud data.

18. The information processing device according to claim 1, wherein the difference adjuster adjusts the index based on an adjustment signal, and
the difference extractor extracts the third point cloud data from the difference based on the index adjusted by the difference adjuster.

19. The information processing device according to claim 18, further comprising: an evaluator configured to evaluate accuracy of the third point cloud data extracted by the difference extractor using the first point cloud data of a test image,
wherein the difference adjuster adjusts the index based on the adjustment signal based on an evaluation result of the evaluator, and
the difference extractor repeats processing of the evaluator and the difference adjuster alternately a predetermined number of times, and then extracts the third point cloud data from the difference based on the index with highest accuracy evaluated by the evaluator.

20. An information processing method comprising:
extracting third point cloud data based on a difference between newly acquired first point cloud data and previously acquired second point cloud data; and
generating an index to adjust an extraction amount of the difference based on the first point cloud data; and
extracting the third point cloud data from the difference based on the index.
